(19) United States
(12) Patent Application Publication
(10) Pub. No.: US 2019/0252658 A1
(43) Pub. Date: Aug. 15, 2019

(54) SEPARATOR AND SECONDARY BATTERY INCLUDING THE SEPARATOR

(71) Applicant: Sumitomo Chemical Company, Limited, Tokyo (JP)

(72) Inventors: Chikae YOSHIMARU, Osaka-shi, Osaka (JP); Chikara MURAKAMI, Osaka-shi, Osaka (JP); Tomoaki OZEKI, Niihama-shi, Ehime (JP)

(21) Appl. No.: 16/344,253

(22) PCT Filed: Oct. 24, 2016
(86) PCT No.: PCT/JP2016/081503

§ 371 Date: Apr. 23, 2019

(51) Int. Cl. H01M 2/16

(52) U.S. Cl. CPC H01M 2/16; H01M 10/0525

(57) ABSTRACT

A separator and a secondary battery including the separator are described. The separator includes a first layer consisting of porous polyolefin. A temperature-increase convergence time to the amount of a resin in the first layer per unit area is at least 2.9 s·m²/g and equal to or shorter than 5.7 s·m²/g when the layer is irradiated with a microwave (frequency 2455 MHz, output of 1800W) after being impregnated with N-methylpyrrolidone containing 3 wt % of water. The tearing strength of the first layer measured by the Elmendorf tearing method (JIS K 7128-2) is at least 1.5 mN/μm, and a tensile elongation value of the first layer is at least 0.5 mm until a load decreases to 25% of a maximum load from when the load reaches the maximum load in a load-elongation curve in the tearing strength measurement (JIS K 7128-3) by the right-angled tearing method.

### FIELD

An embodiment of the present invention relates to a separator and a secondary battery including the separator. For example, an embodiment of the present invention relates to a separator capable of being used in a nonaqueous electrolyte-solution secondary battery and a nonaqueous electrolyte-solution secondary battery including the separator.

### BACKGROUND

As a typical example of a nonaqueous electrolyte-solution secondary battery, a lithium ion secondary battery is represented. Since a lithium-ion secondary battery has a high energy density, it has been widely used in electronic devices such as a personal computer, a mobile phone, and a mobile information terminal. A lithium ion secondary battery includes a positive electrode, a negative electrode, an electrolyte solution charged between the positive electrode and the negative electrode, and a separator. The separator separates the positive electrode and the negative electrode from each other and also functions as a film transmitting the electrolyte solution and carrier ions. For example, Patent Literature 1 discloses a separator including a polyolefin.

In the nonaqueous electrolyte-solution secondary battery, since the electrode repeats expansion and contraction with charge and discharge, stress is generated between the electrode and the separator, the electrode active material is dropped, and the internal resistance is increased, thus, there was a problem that the cycling characteristics decreased. Then, the method of improving the adhesiveness of a separator and an electrode is proposed by coating adhesive substances, such as a polyvinylidene fluoride, on the surface of a separator (Patent Literatures 2 and 3).

On the other hand, in recent years, with the improvement in performance of the nonaqueous electrolyte-solution secondary battery, a nonaqueous electrolyte-solution secondary battery having higher safety is required. In order to ensure the safety and productivity of the battery, it is known that it is effective to control the tearing strength of the separator, which is measured by the Trouser Tear method (in accordance with JIS K 7128-1), in response to such requirements (Patent Literatures 4 and 5).

In addition, it is known that controlling the tearing strength is also effective for film routing and the like (Patent Literatures 6 and 7).

### CITATION LIST

### Patent Literature

### Patent Literature 1: Japanese Patent Application Laid-Open No. 2010-180341

### Patent Literature 2: Japanese Patent No. 5355823

### Patent Literature 3: Japanese Patent Application Laid-Open No. 2001-118558

### Patent Literature 4: Japanese Patent Application Laid-Open No. 2010-111096

### Patent Literature 5: International Patent Publication No. 2013/054884

### Patent Literature 6: Japanese Patent Application Laid-Open No. 2013-163763

### Patent Literature 7: International Patent Publication No. 2005/028553

### SUMMARY OF INVENTION

### Technical Problem

An object of the present invention is to provide a separator capable of being used in a secondary battery such as a nonaqueous electrolyte-solution secondary battery and a secondary battery including the separator.

In addition, an object of the present invention is to provide a separator capable of suppressing a decrease in a rate property when charging and discharging are repeated and suppressing the occurrence of an internal short circuit against an external impact, and a secondary battery including the separator.

### Solution to Problems

An embodiment of the present invention is a separator including a first layer consisting of a porous polyolefin. A temperature-increase convergence time to a unit area per resin amount of the first layer is equal to or longer than 2.9 s·m²/g and equal to or shorter than 5.7 s·m²/g when the first layer is irradiated with a microwave having a frequency of 2455 MHz and an output power of 1800 W after dipping the first layer in N-methylpyrrolidone containing 3 wt % of water, Further, in the first layer, a tearing strength of the first layer measured by the Elmendorf tearing method (in accordance with JIS K 7128-2) is equal to or higher than 1.5 mN/pm, and in a load-tensile elongation curve in a tearing strength measurement (based on JIS K 7128-3) of the first layer by the right-angled tearing method, a value of the tensile elongation from a point when a load reaches the maximum load to a point when it attenuates to 25% of the maximum load is equal to or longer that 0.5 mm.

### Effects of Invention

According to the present invention, it is possible to provide a separator capable of suppressing a decrease in a rate property when charging and discharging are repeated, and suppressing the occurrence of an internal short circuit against an external impact, and a secondary battery including the separator.

### BRIEF DESCRIPTION OF DRAWINGS

FIG. 1 is a respectively schematic cross-sectional view of a secondary battery and a separator according to an embodiment of the present invention.

FIG. 2 shows a calculation method of a tensile elongation.

FIG. 3 shows a schematic perspective view a measuring apparatus of the nail penetration continuity test in the Example of the present invention.

FIG. 4 shows a table showing characteristics of separators and secondary batteries in examples of the present invention.

### DESCRIPTION OF EMBODIMENTS

Hereinafter, the embodiments of the present invention are explained with reference to the drawings and the like. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention.

In the specification and the claims, unless specifically stated, when a state is expressed where a structure is arranged “on” another structure, such an expression includes both a case where the substrate is arranged immediately above the “other structure” so as to be in contact with the “other structure” and a case where the structure is arranged over the “other structure” with an additional structure therebetween.

In the specification and the claims, an expression “substantially including only A” or an expression “consisting of A” includes a state where no substance is included other than A, a state where A and an impurity are included, and a state misidentified as a state where a substance other than A is included due to a measurement error. When this expression means the state where A and an impurity are included, there is no limitation to the kind and concentration of the impurity.

### First Embodiment

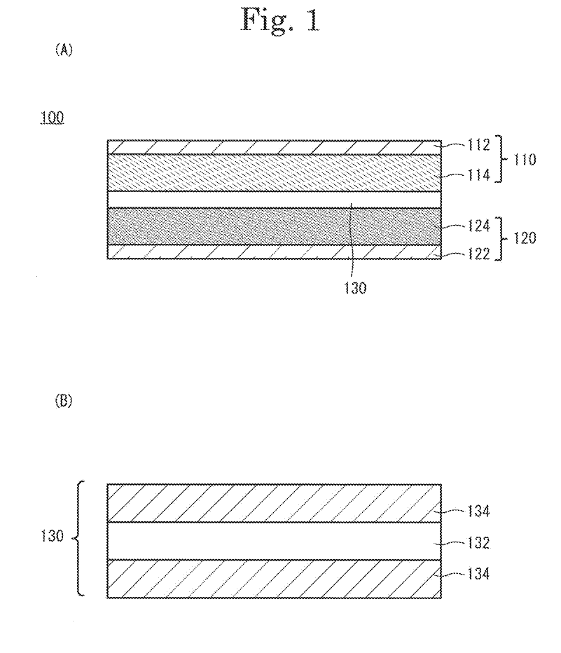

A schematic cross-sectional view of a secondary battery 100 according to an embodiment of the present invention is shown in FIG. 1(A). The secondary battery 100 includes a positive electrode 110, a negative electrode 120, and a separator 130 separating the positive electrode 110 and the negative electrode 120 from each other. Although not illustrated, the secondary battery 100 possesses an electrolyte solution 140. The electrolyte solution 140 mainly exists in apertures of the positive electrode 110, the negative electrode 120, and the separator 130 as well as in the gaps between these members. The positive electrode 110 may include a positive-electrode current collector 112 and a positive-electrode active-substance layer 114. Similarly, the negative electrode 120 may include a negative-electrode current collector 122 and a negative-electrode active-substance layer 124. Although not illustrated in FIG. 1(A), the secondary battery 100 further possesses a housing by which the positive electrode 110, the negative electrode 120, the separator 130, and the electrolyte solution 140 are supported.

### 1. Separator

### 1-1. Structure

The separator 130 is disposed between the positive electrode 110 and the negative electrode 120 and serves as a film having a role of separating the positive electrode 110 and the negative electrode 120 and transporting the electrolyte solution 140 in the secondary battery 100. A schematic cross-sectional view of the separator 130 is shown in FIG. 1(B). The separator 130 has a first layer 132 including a porous polyolefin and may further possess a porous layer 134 as an optional structure. The separator 130 may have a structure in which two porous layers 134 sandwich the first layer 132 as shown in FIG. 1(B), or a structure in which the porous layer 134 is disposed only on one surface of the first layer 132. Alternatively, a structure may be employed where no porous layer 134 is provided. The first layer 132 may have a single-layer structure or may be structured with a plurality of layers.

The first layer 132 has internal pores linked to each other. This structure allows the electrolyte solution 140 to permeate the first layer 132 and enables carrier ions such as lithium ions to be transported via the electrolyte solution 140. At the same time, physical contact between the positive electrode 110 and the negative electrode 120 is inhibited. On the other hand, when the secondary battery 100 has a high temperature, the first layer 132 melts and the pores disappear, thereby stopping the transportation of the carrier ions. This behavior is called shutdown. This behavior prevents heat generation and ignition caused by a short-circuit between the positive electrode 110 and the negative electrode 120, by which high safety is secured.

The first layer 132 includes a porous polyolefin. Alternatively, the first layer 132 may be structured with a porous polyolefin. Namely, the first layer 132 may be configured so as to include only a porous polyolefin or substantially include only a porous polyolefin. The porous polyolefin may contain an additive. In this case, the first layer 132 may be structured only with the polyolefin and the additive or substantially only with the polyolefin and the additive. When the porous polyolefin contains the additive, the polyolefin may be included in the porous polyolefin at a composition equal to or higher than 95 wt %, equal to or higher than 97 wt % or equal to or higher than 99 wt %. Furthermore, the polyolefin may be included in the first layer 132 at a composition equal to or higher than 95 wt % or equal to or higher than 97 wt %. The content of polyolefin in the first layer 132 may be 100 wt % or may be less than 100 wt %. As the additive, an organic compound (organic additive) is represented, and the organic compound may be an antioxidant (organic antioxidant) or a lubricant.

As the polyolefin structuring the porous polyolefin, a homopolymer obtained by polymerizing an α-olefin such as ethylene, propylene, 1-butene, 4-methyl-1-pentene, and 1-hexene or a copolymer thereof is represented. A mixture of these homopolymers and copolymers may be included in the first layer 132 and a mixture of homopolymers and copolymers having different molecular weights may be included. That is, the molecular weight distribution of the polyolefin may have a plurality of peaks. The organic additive may have a function to prevent oxidation of the polyolefin, and phenols or phosphoric esters may be employed as the organic additive, for example. Phenols having a bulky substituent such as t-butyl group at an α-position and/or a β-position of a phenolic hydroxy group may be also used.

As a typical polyolefin, a polyethylene-based polymer is represented. When a polyethylene-based polymer is used, a low-density polyethylene or a high-density polyethylene may be used. Alternatively, a copolymer of ethylene with an α-olefin may be used. These polymers or copolymers may be a high-molecular weight polymer with a weight-average molecular weight equal to or higher than 100,000 or an ultrahigh-molecular weight polymer with a weight-average molecular weight of equal to or higher than 1,000,000. The use of a polyethylene-based polymer enables the shutdown function to be realized at a lower temperature, thereby providing high safety to the secondary battery 100.

A thickness of the first layer 132 may be appropriately determined in consideration of a thickness and the like of other members in the secondary battery 100 and may be equal to or larger than 4 μm and equal to or smaller than 40 μm, equal to or larger than 5 μm and equal to or smaller than 30 μm, or equal to or larger than 6 μm and equal to or smaller than 15 μm.

A weight per unit area of the first layer 132 is appropriately determined in view of its strength, thickness, weight, and handleability. For example, the weight per unit area may be equal to or more than 4 g/m² and equal to or less than 20 g/m², equal to or more than 4 g/m² and equal to or less than 12 g/m², or equal to or more than 5 g/m² and equal to or less than 10 g/m², by which a weight-energy density and a volume-energy density of the secondary battery 100 can be increased. Note that a weight per unit area is a weight per unit area.

With respect to gas permeability of the first layer 132, its Gurley value may be selected from a range equal to or higher than 30 s/100 mL and equal to or lower than 500 s/100 mL or equal to or higher than 50 s/100 mL and equal to or lower than 300 s/100 mL so that sufficient ion-permeability can be obtained.

A porosity of the first layer 132 may be selected from a range equal to or more than 20 vol % and equal to or less than 80 vol % or equal to or more than 30 vol % and equal to or less than 75 vol % so that a retention volume of the electrolyte solution 140 is increased and the shutdown function is surely realized. A diameter of the pore (average pore diameter) in the first layer 132 may be selected from a range equal to or larger than 0.01 μm and equal to or smaller than 0.3 μm or equal to or larger than 0.01 μm and equal to or smaller than 0.14 μm so that a sufficient ion-permeability and a high shutdown function can be obtained.

### 1-2. Property

A temperature-increase convergence time to a unit area per resin amount of the first layer 132 caused by irradiating the first layer 132 with a microwave having a frequency of 2455 Hz and an output power of 1800 W after being dipped in N-methylpyrrolidone containing 3 wt % of water is equal to or longer than 2.9 s·m²/g and equal to or shorter than 5.7 s·m²/g. Further, a tearing strength of the first layer 132 measured by the Elmendorf tearing method (in accordance with JIS K 7128-2) is equal to or higher than 1.5 mN/μm, and in a load-tensile elongation curve in a strength measurement (JIS K 7128-3) of the first layer 132 by the right angle tearing method, the value E of the tensile elongation until it attenuates to 25% of the maximum load from a point when the load reaches the maximum load is equal to or longer than 0.5 mm.

When the secondary battery 100 is charged and discharged, the electrode expands. Specifically, the negative electrode 120 expands during charge, and the positive electrode 110 expands during discharge. Therefore, the electrolyte solution 140 inside the separator 130 is pushed out from the expanding electrode side to the opposing electrode side. By such a mechanism, the electrolyte solution 140 moves in and out of the separator 130 during charge and discharge cycles. Here, since the separator 130 has pores as described above, the electrolytic solution 140 moves in and out of the pores.

When the electrolyte solution 140 moves in the pores of the first layer 132, the wall surfaces of the pores receive stress associated with the movement. The strength of the stress is related to the structure of the pore, ie, the capillary force in the connected pore and the area of the wall of the pore. Specifically, it is considered that the stress received by the wall surface of the pore increases as the capillary force increases and as the area of the wall surface of the pore increases. In addition, the strength of the stress is also related to the amount of electrolyte moving in the pores, and it is considered that the strength of the stress is large when the amount of electrolyte moving is large, that is, when the secondary battery 100 is operated under high current conditions. In addition, if the stress increases, a wall surface will deform so that a pore is obstructed by stress, and a battery output characteristic is reduced as a result. Therefore, the rate property of the secondary battery 100 is gradually deteriorated by repeating the charge and discharge of the secondary battery 100 or operating it under a large current condition.

In addition, when the amount of the electrolyte solution 140 extruded from the first layer 132 is small, a decrease in the electrolyte solution 140 per electrode surface or a local exhaustion of the electrolyte solution 140 on the electrode surface occurs, and it is considered to cause an increase in the generation of electrolytic decomposition products. Such electrolytic decomposition products cause the deterioration of the rate property of the secondary battery 100.

Thus, the structure of the pores of the first layer 132 (capillary force in the pores and the area of the wall of the pores), and the ability to supply the electrolyte solution 140 from the first layer 132 to the electrode relates to the deterioration of the rate property when the charge and discharge of the secondary battery 100 are repeated or the operation is performed under a large current condition. Therefore, the present inventors paid attention to the temperature change when the first layer 132 was impregnated with N-methylpyrrolidone containing 3 wt % of water and irradiated with microwaves with a frequency of 2455 MHz at an output of 1800 W.

When the first layer 132 containing N-methylpyrrolidone with water is irradiated with microwaves, heat is generated by vibrational energy of water. The generated heat is transferred to the resin of the first layer 132 in contact with the N-methylpyrrolidone containing water. Then, the temperature rise converges when the heat generation rate and the cooling rate by heat transfer to the resin are equalized. Therefore, a time for the temperature rise to converge (temperature-increase convergence time) relates to the degree of contact of the liquid contained in the first layer 132 (here, N-methylpyrrolidone containing water) with the resin that constitutes the first layer 132. The degree of contact between the liquid contained in the first layer 132 and the resin constituting the first layer 132 is closely related to the capillary force in the pores of the first layer 132 and the area of the walls of the pores. Therefore, the structure of the pores (capillary force in the pores and the area of the wall of the pores) of the first layer 132 can be evaluated by the above-described temperature-increase convergence time. Specifically, the shorter the temperature-increase convergence time, the larger the capillary force in the pore and the larger the pore wall area.

The degree of contact between the liquid contained in the first layer 132 and the resin constituting the first layer 132 is considered to be larger as the liquid moves more easily in the pores of the first layer 132. Therefore, the supply capability of the electrolytic solution 140 from the separator 130 to the electrode can be evaluated by the temperature-increase convergence time. Specifically, it indicates that the supply capability of the electrolyte solution 140 from the separator 130 to the electrode is higher as the temperature-increase convergence time is shorter.

The first layer 132 has the above-mentioned temperature-increase convergence time with respect to the resin amount per unit area (weight per unit area) equal to or longer than 2.9 s·m²/g and equal to or shorter than 5.7 s·m²/g, preferably equal to or longer than 2.9 s·m²/g and equal to or shorter than 5.3 s·m²/g.

When the temperature-increase convergence time to the resin amount of the first layer 132 per unit area is shorter than 2.9 s·m²/g, the capillary force in the pores of the first layer 132 and the area of the wall of the pores becomes too large, the stress on the pore wall increases when the electrolyte 140 moves in the pore during charge/discharge cycles or operation under large current conditions, and the pore is clogged, resulting in a degraded cell output property.

In addition, when the temperature-increase convergence time with respect to the resin amount of the first layer 132 per unit area exceeds 5.7 s·m²/g, it becomes difficult for the liquid to move in the pores of the first layer 132. In the case where the first layer 132 is used as the separator 130, the rate of movement of the electrolyte near the interface between the first layer 132 and the electrode is reduced and the rate property of the battery is degraded. In addition, when charge and discharge of the battery are repeated, local electrolytic solution-depleted portions are likely to be generated locally at the interface between the separator 130 and the electrode and inside the first layer 132. As a result, the internal resistance of the secondary battery 100 is increased, and the rate property after charge and discharge cycles of the secondary battery 100 is degraded.

On the other hand, by setting the temperature-increase convergence time to the resin amount of the first layer 132 per unit area to be equal to or longer than 2.9 s·m²/g and equal to or shorter than 5.7 s·m²/g, it is possible to suppress the decrease in rate property after the charge/discharge cycle.

In the specification and claims, the tensile strength is a tearing force measured according to “JIS K 7128-2 Tearing Strength Test Method of Plastic Film and Sheet-2nd Part: Elmendorf Tearing Method” regulated by the Japan Industrial Standards (JIS). Specifically, the tearing force is measured using the separator 130 having a rectangular shape based on the JIS Regulation where the swing angle of a pendulum is set to be 68.4° and the tearing direction in the measurement is set in the TD of the separator 130. The measurement is carried out in a state where 4 to 8 separators are stacked, and the obtained tearing load is divided by the number of the measured separators to calculate the tearing strength per one separator 130. The tearing strength per one separator 130 is further divided by the thickness of the separator 130 to calculate the tearing strength T per 1 μm thickness of the separator 130.

That is, the tearing strength T is calculated by the following equation:

T=(F/d)

where F is the tearing load (mN) per one separator 130 obtained by the measurement, d is the thickness (μm) of the separator 130, and the unit of the tearing strength T is mN/μm.

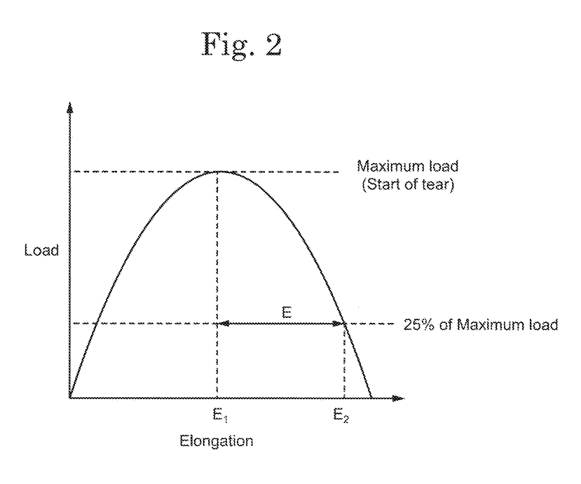

In the specification and claims, the tensile elongation E is an elongation of the separator 130 calculated from the load-elongation curve obtained by the measurement based on the “JIS K 7128-3 Tearing Strength Test Method of Plastic Film and Sheet-3rd Part: Rectangular Tearing Method” regulated by the JIS. The separator 130 is processed into the shape based on the JIS Regulation and is stretched at an elongating rate of 200 mm/min while arranging the tearing direction in the TD. Since the stretching direction and the tearing direction are reversed, the stretching direction is the MD, while the tearing direction is the TD. That is, the separator 130 becomes a shape long in the MD. The load-elongation curve obtained by the measurement under these conditions is schematically shown in FIG. 2. The tensile elongation E is an elongation (E₂−E₁) from the time when the load applied to the separator 130 reaches a maximum (when the maximum load is applied) until the time when the load applied to the separator 130 decreases to 25% of the maximum load.

In the first layer 132, the tearing strength by the Elmendorf tearing method is equal to or larger than 1.5 mN/μm, preferably equal to or larger than 1.75 mN/μm, more preferably equal to or larger than 2.0 mN/μm. Further. It is preferably equal to or smaller than 10 mN/μm, more preferably equal to or smaller than 4.0 mN/μm. When the tearing strength (tear direction: TD direction) by the Elmendorf tearing method is equal to or larger than 1.5 mN/μm, the first layer 132, that is, the separator 130 and the separator 130 having the first layer 132 and the porous layer 134 is less likely to generate an internal short circuit even when it receives an impact.

In the first layer 132, the tensile elongation value E based on the right-angled tearing method is equal to or longer than 0.5 mm, preferably equal to or longer than 0.75 mm and more preferably equal to or longer than 1.0 mm. Moreover, it is preferably equal to or longer than 10 mm. When the tensile elongation value E based on the right-angled tearing method is equal to or longer than 0.5 mm, the first layer 132, that is, the separator 130, and the separator 130 including the first layer 132 and the porous layer 134 tend to be able to suppress the rapid occurrence of a large internal short circuit even when receiving an external impact.

As described above, because the separator 130 according to the present invention has a temperature-increase convergence time to a unit area per resin amount of the first layer is equal to or longer than 2.9 s·m²/g and equal to or shorter than 5.7 s·m²/g when the first layer is irradiated with a microwave having a frequency of 2455 MHz and an output power of 1800 W after dipping the first layer in N-methylpyrrolidone containing 3 wt % of water, tearing strength equal to or larger than 1.5 mN/μm of the first layer 132 measured by the Elmendorf tear method (in accordance with JIS K 7128-2), and the value E of the tensile elongation equal to or longer than 0.5 mm from a point when the load reaches the maximum load to a point when it attenuates to 25% of the maximum load in the load-tensile elongation curve in the tearing strength measurement (in accordance with JIS K 7128-3) of the first layer 132 by the right-angled tear method, a separator and a secondary battery including the separator capable of suppressing a decrease in a rate property when charging and discharging are repeated, and capable of suppressing the occurrence of an internal short circuit against an external impact can be provided.

### 2. Electrode

As described above, the positive electrode 110 may include the positive-electrode current collector 112 and the positive-electrode active-substance layer 114. Similarly, the negative electrode 120 may include the negative-electrode current collector 122 and the negative-electrode active-substance layer 124 (see FIG. 1(A)). The positive-electrode current collector 112 and the negative-electrode current collector 122 respectively possess the positive-electrode active-substance layer 114 and the negative-electrode active-substance layer 124 and have functions to supply current to the positive-electrode active-substance layer 114 and the negative-electrode active-substance layer 124, respectively.

A metal such as nickel, copper, titanium, tantalum, zinc, iron, and cobalt or an alloy such as stainless including these metals can be used for the positive-electrode current collector 112 and the negative-electrode current collector 122, for example. The positive-electrode current collector 112 and the negative-electrode current collector 122 may have a structure in which a plurality of layers including these metals or alloys is stacked.

The positive-electrode active-substance layer 114 and the negative-electrode active-substance layer 124 respectively include a positive-electrode active substance and a negative-electrode active substance. The positive-electrode active substance and the negative-electrode active substance have a role to release and absorb carrier ions such as lithium ions.

As a positive-electrode active substance, a material capable of being doped or de-doped with carrier ions is represented, for example. Specifically, a lithium-based composite oxide containing at least one kind of transition metals such as vanadium, manganese, iron, cobalt, and nickel is represented. As such a composite oxide, a lithium-based composite oxide having an α-NaFeO₂-type structure, such as lithium nickelate and lithium cobalate, and a lithium-based composite oxide having a spinel-type structure, such as lithium manganese spinel, are given. These composite oxides have a high average discharge potential.

The lithium-based composite oxide may contain another metal element and is exemplified by lithium nickelate (composite lithium nickelate) including an element selected from titanium, zirconium, cerium, yttrium, vanadium, chromium, manganese, iron, cobalt, copper, silver, magnesium, aluminum, gallium, indium, tin, and the like, for example. These metals may be adjusted to be equal to or more than 0.1 mol % and equal to or less than 20 mol % to the metal elements in the composite lithium nickelate. This structure provides the secondary battery 100 with an excellent rate maintenance property when used at a high capacity. For example, a composite lithium nickelate including aluminum or manganese and containing nickel at 85 mol % or more or 90 mol % or more may be used as the positive-electrode active substance.

Similar to the positive-electrode active substance, a material capable of being doped and de-doped with carrier ions can be used as the negative-electrode active substance. For example, a lithium metal or a lithium alloy is represented. Alternatively, it is possible to use a carbon-based material such as graphite exemplified by natural graphite and artificial graphite, cokes, carbon black, and a sintered polymeric compound exemplified by carbon fiber; a chalcogen-based compound capable of being doped and de-doped with lithium ions at a potential lower than that of the positive electrode, such as an oxide and a sulfide; an element capable of being alloyed or reacting with an alkaline metal, such as aluminum, lead, tin, bismuth, and silicon; an intermetallic compound of cubic system (AlSb, Mg₂Si, NiSi₂) undergoing alkaline-metal insertion between lattices; lithium-nitride compound (Li₃₋ₓMₓN (M: transition metal)); and the like. Among the negative-electrode active substances, the carbon-based material including graphite such as natural graphite and artificial graphite as a main component provides a large energy density due to high potential uniformity and a low average discharge potential when combined with the positive electrode 110. For example, it is possible to use, as the negative-electrode active substance, a mixture of graphite and silicon with a ratio of silicon to carbon equal to or larger than 5 mol % and equal to or smaller 10 mol %.

The positive-electrode active-substance layer 114 and the negative-electrode active-substance layer 124 may each further include a conductive additive and binder other than the aforementioned positive-electrode active substance and the negative-electrode active substance.

As a conductive additive, a carbon-based material is represented. Specifically, graphite such as natural graphite and artificial graphite, cokes, carbon black, pyrolytic carbons, and a sintered polymeric compound such as carbon fiber are given. A plurality of materials described above may be mixed to use as a conductive additive.

As a binder, poly(vinylidene fluoride) (PVDF), polytetrafluoroethylene, poly(vinylidene fluoride-co-hexafluoropropylene), poly(tetrafluoroethylene-co-hexafluoropropylene), poly(tetrafluoroethylene-co-perfluoroalkyl vinyl ether), poly(ethylene-co-tetrafluoroethylene), a copolymer in which vinylidene fluoride is used as a monomer, such as a poly(vinylidene fluoride-co-hexafluoropropylene-co-tetrafluoroethylene), a thermoplastic resin such as a thermoplastic polyimide, polyethylene, and polypropylene, an acrylic resin, styrene-butadiene rubber, and the like are represented. Note that a binder may further have a function as a thickener.

The positive electrode 110 may be formed by applying a mixture of the positive-electrode active substance, the conductive additive, and the binder on the positive-electrode current collector 112, for example. In this case, a solvent may be used to form or apply the mixture. Alternatively, the positive electrode 110 may be formed by applying a pressure to the mixture of the positive-electrode active substance, the conductive additive, and the binder to process the mixture and arranging the processed mixture on the positive electrode 110. The negative electrode 120 can also be formed with a similar method.

### 3. Electrolyte Solution

The electrolyte solution 140 includes the solvent and an electrolyte, and at least a part of the electrolyte is dissolved in the solvent and electrically dissociated. As the solvent, water and an organic solvent can be used. In the case where the secondary battery 100 is utilized as a nonaqueous electrolyte-solution secondary battery, an organic solvent is used. As an organic solvent, carbonates such as ethylene carbonate, propylene carbonate, dimethyl carbonate, diethyl carbonate, ethyl methyl carbonate, and 1,2-di(methoxycarbonyloxy)ethane; ethers such as 1,2-dimethoxyethane, 1,3-dimethoxypropane, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone, sulfur-containing compounds such as sulfolane, dimethyl sulfoxide, and 1,3-propanesultone; a fluorine-containing organic solvent in which fluorine is introduced to the aforementioned organic solvent; and the like are represented. A mixed solvent of these organic solvents may also be employed.

As a typical electrolyte, a lithium salt is represented. For example, LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, a lithium salt of a carboxylic acid having 2 to 6 carbon atoms, LiAlCl₄, and the like are represented. Just one kind of the lithium salts mentioned above may be used, and more than two kinds of lithium salts may be combined.

Note that, in a broad sense, an electrolyte may mean a solution of an electrolyte. However, in the present specification and claims, a narrow sense is employed. That is, an electrolyte is a solid and is electrically dissociated upon dissolving in a solvent to provide an ion conductivity to the resulting solution.

### 4. Fabrication Process of Secondary Battery

As shown in FIG. 1(A), the negative electrode 120, the separator 130, and the positive electrode 110 are arranged to form a stacked body. After that, the stacked body is disposed in a housing which is not illustrated. The secondary battery 100 can be fabricated by filling the housing with the electrolyte solution and sealing the housing while reducing a pressure in the housing or by sealing the housing after filing the housing with the electrolyte solution while reducing a pressure in the housing. A shape of the secondary battery 100 is not limited and may be a thin-plate (paper) form, a disc form, a cylinder form, a prism form such as a rectangular parallelepiped, or the like.

### Second Embodiment

In the present embodiment, a method for preparing the first layer 132 described in the First Embodiment is described. An explanation of the structures the same as those of the First Embodiment may be omitted.

A method for preparing the first layer 132 includes (1) a process for obtaining a polyolefin resin composite by kneading an ultrahigh-molecular weight polyethylene, a low-molecular weight polyolefin, and a pore-forming agent, (2) a process for forming a sheet by rolling the polyolefin resin composite with a rolling roll (rolling process), (3) a process for removing the pore-forming agent from the sheet obtained in the process (2), and (4) a process for processing into a film state by stretching the sheet obtained in the process (3). The order of the process (3) and the process (4) may be reversed.

### 1. Process (1)

There is no limitation on the shape of the ultrahigh-molecular weight polyethylene, and for example, a polyolefin processed into powder can be used. The weight average molecular weight of the low-molecular weight polyolefin is, for example, 200 or more and 3,000 or less. Thus, the volatilization of the low-molecular weight polyolefin can be suppressed, and the low-molecular weight polyolefin can be uniformly mixed with the ultrahigh-molecular weight polyolefin. In the present specification and claims, polymethylene is also defined as a type of polyolefin.

The pore-forming agent includes an organic filler and an inorganic filler. As the organic filler, for example, a plasticizer may be used, and as the plasticizer, a low-molecular weight hydrocarbon such as a liquid paraffin and a mineral oil can be exemplified as a plasticizer.

As an inorganic filler, an inorganic material soluble in a neutral, acidic, or alkaline solvent is represented, and calcium carbonate, magnesium carbonate, barium carbonate, and the like are exemplified. Other than these materials, an inorganic compound such as calcium chloride, sodium chloride, and magnesium sulfate is represented.

The pore-forming agent may be used alone or in combination of two or more. Calcium carbonate is exemplified as a typical pore-forming agent.

The weight ratio of each material can be, for example, the low molecular weight polyolefin equal to or more than 5 weight portions and equal to or less than 200 weight portions and the pore-forming agent equal to or more than 100 weight portions and equal to or less than 400 weight portions to 100 weight portions of the ultrahigh-molecular weight polyethylene. At this time, an organic additive may be added. The amount of the organic additive can be equal to or less than 1 weight portions and equal to or less than 10 weight portions, equal to or more than 2 weight portions and equal to or less than 7 weight portions, or equal to or more than 3 weight portions and equal to or less than 5 weight portions to 100 weight portions of the ultrahigh-molecular weight polyethylene.

### 2. Process (2)

In step (2), the polyolefin resin composition can be processed into a sheet shape using a T-die molding method at a temperature, for example, equal to or higher than 245° C. and equal to or lower than 280° C., or equal to or higher than 245° C. and equal to or lower than 260° C.

### 3. Process (3)

In the process (3) in which the pore-forming agent is removed, a solution of water or organic solvent to which an acid or a base is added, or the like is used as a cleaning solution. A surfactant may be added to the cleaning solution. An addition amount of the surfactant can be arbitrarily selected from a range equal to or more than 0.1 wt % to 15 wt % or equal to or more than 0.1 wt % and equal to or less than 10 wt %. It is possible to secure a high cleaning efficiency and prevent the surfactant from being left by selecting the addition amount from this range. A cleaning temperature may be selected from a temperature range equal to or higher than 25° C. and equal to or lower than 60° C., equal to or higher than 30° C. and equal to or lower than 55° C., or equal to or higher than 35° C. and equal to or lower than 50° C., by which a high cleaning efficiency can be obtained and evaporation of the cleaning solution can be avoided.

In the process (3), water cleaning may be further conducted after removing the pore-forming agent with the cleaning solution. The temperature in the water cleaning may be selected from a temperature range equal to or higher than 25° C. and equal to or lower than 60° C., equal to or higher than 30° C. and equal to or lower than 55° C., or equal to or higher than 35° C. and equal to or lower than 50° C. By the process (3), the first layer 132 containing no pore-forming agent can be obtained.

### 4. Process (4)

The structure of the pores of the first layer 132 (capillary force of pores, area of wall of pores, residual stress inside porous film) is influenced by the strain rate at the time of stretching in step (4) and the temperature (heat setting temperature per film unit thickness after drawing) of the heat setting process (annealing treatment) after stretching per unit film thickness after stretching. Therefore, by adjusting the strain rate and the heat setting temperature per unit film thickness after stretching, it is possible to control the temperature-increase convergence time relative to the resin amount per unit area of the structure of the pores of the first layer 132.

Specifically, there is a tendency that the first layer 132 according to the present embodiment can be obtained by adjusting the strain rate and the heat setting temperature per the film unit thickness after stretching is in the range of the inside of a triangle having three points (500% per minute, 1.5° C./μm), (900%, 12.5° C./μm), (2500%, 11.0° C./μm) on the graph with the strain rate as the X axis and the heat setting temperature per film unit thickness after stretching as the Y axis. Preferably, the strain rate and the heat setting temperature per unit film thickness after drawing are adjusted to the conditions inside the triangle having three apexes of three points (600% per minute, 5.0° C./μm), (900%, 12.5° C./μm) and (2500%, 11.0° C./μm).

### [Control of Values of Tearing Strength and Tensile Elongation]

As a method of improving the values of the tearing strength and the tensile elongation of the first layer 132 in the present invention, (a) improving the internal uniformity of the first layer 132, (b) reducing the proportion of the skin layer on the surface of the first layer 132, or (c) reducing the difference in crystal orientation in the TD direction and the MD direction of the first layer 132, can be exemplified.

As a method of improving the internal uniformity of the first layer 132, a method of removing the aggregate in the mixture using the metallic mesh from the mixture obtained by kneading the raw material of the first layer 132 in the process (1) is exemplified. By removing the aggregate, it is considered that the internal uniformity of the obtained first layer 132 is improved and the first layer 132 becomes locally difficult to tear and its tearing strength is improved. In addition, since the aggregate in the polyolefin resin composition obtained by the process (1) decreases, it is preferable that the mesh of the metallic mesh is fine.

The rolling in the process (2) generates a skin layer on the surface of the obtained first layer 132. Since the skin layer is fragile to an external impact, the first layer 132 is weak against tearing and its tearing strength is reduced if the proportion occupied by the skin layer is large. As a method for reducing the proportion of the skin layer in the first layer 132, it is exemplified that a sheet to be a target of the step (3) becomes a single layer sheet.

It is considered that, due to the small difference in crystal orientation between the TD direction and the MD direction in the first layer 132, the first layer 132 becomes uniform in elongation against impacts and tension from the outside and becomes difficult to split. As a method of reducing the difference in crystal orientation in the TD direction and the MD direction in the first layer 132, rolling with a thick film thickness in the step (2) can be exemplified. It is thought that when rolled with a thin film thickness, the obtained porous film has a very strong orientation in the MD direction and has high strength against impacts in the TD direction, but when it begins to split it tears in the orientation direction (MD direction) at once. In other words, It is believed that when rolling with a thick film thickness, the rolling speed increases, the crystal orientation in the MD direction decreases, the difference in crystal orientation in the TD direction and the MD direction decreases, and the obtained first layer 132 does not tear at a stretch after it begins to tear, and its tensile elongation value improves.

### [Pin-Releasability]

As described above, the first layer 132 according to the present embodiment has a tensile elongation value equal to or longer than 0.5 mm because the difference in crystal orientation between the TD direction and the MD direction is small. In other words, the first layer 132 has a good balance of crystal orientation in the TD direction and the MD direction. Due to this, the first layer 132 has a good pin-releasability which serves as a measure of ease of pulling out the pin from the first layer 132 wound around the pin as a core. Therefore, the separator 130 including the first layer 132 can be suitably used for the production of a wound secondary battery such as cylindrical or square, etc. by manufacturing with an assembly method including the step of superposing the separator 130 and the positive and negative electrodes and winding on a pin.

In addition, the amount of extension of the separator 130 is preferably less than 0.2 mm, more preferably less than 0.15 mm, and still more preferably less than 0.1 mm. If the pin-releasability is poor, when removing the pin at the time of manufacturing the battery, the force is concentrated between the base and the pin, and the separator 130 may be damaged. Further, if the amount of extension of the separator 130 is large, the positions of the electrode and the separator 130 may be shifted at the time of battery manufacture, which may cause problems in manufacturing.

Through the above steps, the first layer 132 can be obtained which can suppress a decrease in a rate property when charging and discharging are repeated, and can suppress the occurrence of an internal short circuit against an external impact.

### Third Embodiment

In the present embodiment, an embodiment in which the separator 130 has the porous layer 134 in addition to the first layer 132 is explained.

### 1. Structure

As described in the First Embodiment, the porous layer 134 may be disposed on one side or both sides of the first layer 132 (see FIG. 1(B)). When the porous layer 134 is stacked on one side of the first layer 132, the porous layer 134 may be arranged on a side of the positive electrode 110 or on a side of the negative electrode 120 of the first layer 132.

The porous layer 134 is insoluble in the electrolyte solution 140 and is preferred to include a material chemically stable in a usage range of the second battery 100. As such a material, it is possible to represent a polyolefin such as polyethylene, polypropylene, polybutene, poly(ethylene-co-propylene); a fluorine-containing polymer such as poly(vinylidene fluoride) and polytetrafluoroethylene; a fluorine-containing polymer such as vinylidene fluoride-hexafluoropropylene copolymer, vinylidene fluoride-hexafluoropropylene-tetrafluoroethylene copolymer and ethylene-tetrafluoroethylene copolymer; an aromatic polyimide (aramide); rubber such as poly(styrene-co-butadiene) and a hydride thereof, a copolymer of methacrylic esters, a poly(acrylonitrile-co-acrylic ester), a poly(styrene-co-acrylic ester), ethylene-propylene rubber, and poly(vinyl acetate); a polymer having a melting point and a glass-transition temperature of 180° C. or more, such as poly(phenylene ether), a polysulfone, a poly(ether sulfone), polyphenylenesulfide, a poly(ether imide), a polyamide-imide, a polyether-amide, and a polyester; a water-soluble polymer such as poly(vinyl alcohol), poly(ethylene glycol), a cellulose ether, sodium alginate, poly(acrylic acid), polyacrylamide, poly(methacrylic acid); and the like.

As an aromatic polyimide, poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylenecarboxylic amide), poly(metaphenylene-4,4′-biphenylenecarboxilic amide), poly(paraphenyelnee-2,6-natphthalenedicarboxlic amide), poly(metaphenyelnee-2,6-natphthalenedicarboxlic amide), poly(2-chloroparaphenylene terephthalamide), a copolymer of paraphenylene terephthalamide with 2,6-dichloroparaphenylene terephthalamide, a copolymer of metaphenylene terephthalamide with 2,6-dichloroparaphenylene terephthalamide, and the like are represented, for example.

The porous layer 134 may include a filler. A filler consisting of an organic substance or an inorganic substance is represented as a filler. A filler called a filling agent and consisting of an inorganic substance is preferred. A filler consisting of an inorganic oxide such as silica, calcium oxide, magnesium oxide, titanium oxide, alumina, mica, zeolite, aluminum hydroxide, boehmite, and the like is more preferred, at least one kind of filler selected from a group consisting of silica, magnesium oxide, titanium oxide, aluminum hydroxide, boehmite, and alumina is further preferred, and alumina is especially preferred. Alumina has a number of crystal forms such as α-alumina, β-alumina, γ-alumina, θ-alumina, and the like, and any of the crystal forms can be appropriately used. Among them, α-alumina is most preferable due to its particularly high thermal stability and chemical stability. Just one kind of filler may be used, or two or more kinds of filler may be combined in the porous layer 134.

No limitation is provided to a shape of the filler, and the filler may have a sphere shape, a cylindrical shape, an elliptical shape, a gourd shape, and the like. Alternatively, a filler in which these shapes are mixed may be used.

When the porous layer 134 includes the filler, an amount of the filler to be included may be equal to or larger than 1 vol % and equal to or smaller than 99 vol % or equal to or larger than 5 vol % and equal to or smaller than 95 vol % with respect to the porous layer 134. The aforementioned range of the amount of the filler to be included prevents the space formed by contact between the fillers from being closed by the material of the porous layer 134, which leads to sufficient ion permeability and allows its weight per unit area to be adjusted.

A thickness of the porous layer 134 can be selected from a range equal to or larger than 0.5 μm and equal to or smaller than 15 μm or equal to or larger than 2 μm and equal to or smaller than 10 μm. Hence, when the porous layers 134 are formed on both sides of the first layer 132, a total thickness of the porous layers 134 may be selected from a range equal to or larger than 1.0 μm and equal to or smaller than 30 μm or equal to or larger than 4 μm and equal to or smaller than 20 μm.

When the total thickness of the porous layers 134 is arranged to be equal to or larger than 1.0 μm, internal short-circuits caused by damage to the secondary battery 100 can be more effectively prevented. The total thickness of the porous layers 134 equal to or smaller than 30 μm prevents an increase in permeation resistance of the carrier ions, thereby preventing deterioration of the positive electrode 110 and a decrease in rate property resulting from an increase in permeation resistance of the carrier ions. Moreover, it is possible to avoid an increase in distance between the positive electrode 110 and the negative electrode 120, which contributes to miniaturization of the secondary battery 100.

The weight per unit area of the porous layer 134 may be selected from a range equal to or more than 1 g/m² and equal to or less than 20 g/m² or equal to or more than 2 g/m² and equal to or less than 10 g/m². This range increases an energy density per weight and energy density per volume of the secondary battery 100.

A porosity of the porous layer 134 may be equal to or more than 20 vol % and equal to or less than 90 vol % or equal to or more than 30 vol % and equal to or less than 80 vol %. This range allows the porous layer 134 to have sufficient ion permeability. An average porous diameter of the pores included in the porous layer 134 may be selected from a range equal to or larger than 0.01 μm and equal to or smaller than 1 μm or equal to or larger than 0.01 μm and equal to or smaller than 0.5 μm, by which a sufficient ion permeability is provided to the secondary battery 100 and the shutdown function can be improved.

A gas permeability of the separator 130 including the aforementioned first layer 132 and the porous layer 134 may be equal to or higher than 30 s/100 mL and equal to or lower than 1000 s/100 mL or equal to or higher than 50 s/100 mL and equal to or lower than 800 s/100 L in a Gurley value, which enables the separator 130 to have sufficient strength, maintain a high shape stability at a high temperature, and possess sufficient ion permeability.

### 2. Preparation Method

When the porous layer 134 including the filler is prepared, the aforementioned polymer or resin is dissolved or dispersed in a solvent, and then the filler is dispersed in this mixed liquid to form a dispersion (hereinafter, referred to as a coating liquid). As a solvent, water; an alcohol such as methyl alcohol, ethyl alcohol, n-propyl alcohol, isopropyl alcohol, and t-butyl alcohol; acetone, toluene, xylene, hexane, N-methylpyrrolidone, N,N-dimethylacetamide, N,N-dimethylformamide; and the like are represented. Just one kind of solvent may be used, or two or more kinds of solvents may be used.

When the coating liquid is prepared by dispersing the filler to the mixed liquid, a mechanical stirring method, an ultrasonic dispersing method, a high-pressure dispersion method, a media dispersion method, and the like may be applied. In addition, after the filler is dispersed in the mixed liquid, the filler may be subjected to wet milling by using a wet-milling apparatus.

An additive such as a dispersant, a plasticizer, a surfactant, or a pH-adjusting agent may be added to the coating liquid.

After the preparation of the coating liquid, the coating liquid is applied on the first layer 132. For example, the porous layer 134 can be formed over the first layer 132 by directly coating the first layer 132 with the coating liquid by using a dip-coating method, a spin-coating method, a printing method, a spraying method, or the like and then removing the solvent. Instead of directly applying the coating liquid over the first layer 132, the porous layer 134 may be transferred onto the first layer 132 after being formed on another supporting member. As a supporting member, a film made of a resin, a belt or drum made of a metal may be used.

Any method selected from natural drying, fan drying, heat drying, and vacuum drying may be used to remove the solvent. Drying may be conducted after substituting the solvent with another solvent (e.g., a solvent with a low boiling point). When heating, drying may be carried out at 10° C. or higher and 120° C. or lower or at 20° C. or higher and 80° C. or lower. This temperature range avoids a reduction in gas permeability caused by shrinkage of the pores in the first layer 132.

A thickness of the porous layer 134 can be controlled by a thickness of the coating film in a wet state after coating, an amount of the filler included, a concentration of the polymer and the resin, and the like.

### EXAMPLES

### 1. Preparation of Separator

An example for preparing the separator 130 is described below.

### 1-1. Example 1

To a mixture of 68 wt % of ultrahigh-molecular weight polyethylene powder (GUR20247 manufactured by Ticona) and 32 wt % of polyethylene wax (FNP-0115, manufactured by Nippon Seiro Co. Ltd.) having a weight-average molecular weight of 1000, 0.4 wt % of an antioxidant (Irg1010, manufactured by CIBA Speciality Chemicals), 0.1 wt % of another antioxidant (P168 manufactured by CIBA Speciality Chemicals®), and 1.3 wt % of sodium stearate with respect to 100 weight portions of the summation of the ultrahigh-molecular weight polyethylene and the polyethylene wax were added, calcium carbonate (manufactured by Maruo Calcium Co. LTD.) with an average pore diameter of 0.1 μm was further added so that its proportion to the entire volume is 38 vol %, these were mixed as a powder using a Henschel mixer. After these, the obtained mixture was melt-kneaded while being melted with a twin-screw kneader, and then filtered with a 300-mesh metal mesh to obtain a polyolefin-resin composite. This mixture was rolled using a pair of rolling rollers having a surface temperature of 150° C., the mixture was cooled stepwise while being drawn with a winding roller different in speed from the rolling rollers (drawing ratio (winding speed/rolling speed)=1.4), resulting in a single-layered sheet.

Calcium carbonate is removed by immersing the monolayer sheet in an aqueous solution of hydrochloric acid (4 mol/L of hydrochloric acid, 0.5 wt % of a nonionic surfactant), and then the film was stretched 6.2 times at 100° C. and a strain rate of 1250% per minute, and heat set at 126° C. to obtain a first layer 132.

### 1-2. Example 2

70 wt % of ultrahigh-molecular weight polyethylene powder (GUR4032, manufactured by Ticona), 30 wt % of polyethylene wax (FNP-0115, manufactured by Nippon Seiro Co., Ltd.) with a weight average molecular weight of 1000, when the total of this ultrahigh-molecular weight polyethylene and polyethylene wax set to 100 weight portions, an antioxidant (Irg1010, manufactured by Ciba Specialty Chemicals) 0.4 wt %, another antioxidant (P168 manufactured by Ciba Specialty Chemicals) 0.1 wt %, 1.3 wt % of sodium stearate were added, calcium carbonate (manufactured by Maruo Calcium Co. LTD.) with an average pore diameter of 0.1 μm was further added so that its proportion to the entire volume is 38 vol %, these were mixed using a Henschel mixer the obtained mixture was melt-kneaded with a twin-screw kneader, and passed through a 200-mesh metal mesh to obtain a polyolefin resin composition. The polyolefin resin composition is rolled with a pair of rolls having a surface temperature of 150° C., and is gradually cooled while being pulled by rolls having different speed ratios, and 1.4 times of draw ratio (winding roll speed/rolling roll speed) to produce a single-layered sheet having a thickness of about 41 μm. Next, in the same manner, a single-layered sheet having a thickness of about 68 μm and a draw ratio of 1.2 was produced. The obtained single-layered sheets were pressure-bonded by a pair of rolls having a surface temperature of 150° C. to produce a laminated sheet.

The laminated sheet was immersed in a hydrochloric acid aqueous solution (4 mol/L of hydrochloric acid, 0.5 wt % of a nonionic surfactant) to remove calcium carbonate, and subsequently stretched in TD by 6.2 times at 105° C. and a strain rate of 1250% per minute, and heat set at 126° C. to obtain a first layer 132.

An Example of the preparation of a separator used as a Comparative Example will be described below.

### 1-3. Comparative Example 1

To a mixture of 70 wt % of ultrahigh-molecular weight polyethylene powder (GUR4032 manufactured by Ticona) and 30 wt % of polyethylene wax (FNP-0115, manufactured by Nippon Seiro Co. Ltd.) having a weight-average molecular weight of 1000, 0.4 wt % of an antioxidant (Irg1010, manufactured by CIBA Speciality Chemicals), 0.1 wt % of another (P168 manufactured by CIBA Speciality Chemicals®), and 1.3 wt % of sodium stearate with respect to 100 weight portions of the summation of the ultrahigh-molecular weight polyethylene and the polyethylene wax were added, and calcium carbonate (manufactured by Maruo Calcium Co. LTD.) with an average pore diameter of 0.1 μm was added so that its proportion to the entire volume is 36 vol %. These materials were mixed as a powder with a Henschel mixer and the materials were kneaded while being melted, and then filtered with a 200-mesh metal mesh to obtain a polyolefin-resin composite. This mixture was rolled using a pair of rollers having a surface temperature of 150° C. and cooled stepwise while being drawn with a winding roller different in speed from the rollers (drawing ratio (winding speed/rolling speed)=1.4), resulting in a sheet with a thickness of 29 μm. Next, in the same manner, a single-layered sheet having a film thickness of about 50 μm and a draw ratio of 1.2 was produced. The obtained single-layered sheets were pressure-bonded by a pair of rolls having a surface temperature of 150° C. to produce a laminated sheet. The calcium carbonate is removed by immersing the sheet in an aqueous solution of hydrochloric acid (4 mol/L of hydrochloric acid, 0.5 wt % of a nonionic surfactant), and subsequently, the film was stretched 6.2 times at 105° C. and the strain rate of 2000% per minute to obtain a film having a thickness of 16.3 μm. Further, heat setting was performed at 123° C. to obtain a first layer 132.

### 1-4. Comparative Example 2

A commercially available polyolefin porous film (manufactured by Celgard, #2400) was used as the separator of the comparative example.

### 2. Fabrication of Secondary Battery

A method for fabricating the secondary batteries including the separators of the Example and Comparative Example are described below.

### 2-1. Positive Electrode

A commercially available positive electrode manufactured by applying a stack of LiNi_{0.5}Mn_{0.3}Co_{0.2}O₂/conductive material/PVDF (weight ratio of 92/5/3) on an aluminum foil was processed. Here, LiNi_{0.5}Mn_{0.3}Co_{0.2}O₂ is an active-substance layer. Specifically, the aluminum foil was cut so that a size of the positive-electrode active-substance layer is 45 mm×30 mm and that a portion with a width of 13 mm, in which the positive-electrode active-substance layer is not formed, was left in a periphery and was used as a positive electrode in the following fabrication process. A thickness, a density, and a positive-electrode capacity of the positive-electrode active-substance layer were 58 μm, 2.50 g/cm³, and 174 mAh/g, respectively.

### 2-2. Negative Electrode

A commercially available negative electrode manufactured by applying graphite/poly(styrene-co-1,3-butadiene)/carboxymethyl cellulose sodium salt (weight ratio of 98/1/1) on a copper foil was used. Here, the graphite functions as a negative-electrode active-substance layer. Specifically, the copper foil was cut so that a size of the negative-electrode active-substance layer is 50 mm×35 mm and that a portion with a width of 13 mm, in which the negative-electrode active-substance layer is not formed, was left in a periphery and was used as a negative electrode in the following fabrication process. A thickness, a density, and a negative-electrode capacity of the negative-electrode active-substance layer were 49 μm, 1.40 g/cm³, and 372 mAh/g, respectively.

### 2-3. Fabrication

The positive electrode, the separator, and the negative electrode were stacked in the order in a laminated pouch to obtain a stacked body. At this time, the positive electrode and the negative electrode were arranged so that the entire top surface of the positive-electrode active-substance layer overlaps with a main surface of the negative-electrode active-substance layer.

Next, the stacked body was arranged in an envelope-shaped housing formed by stacking an aluminum layer and a heat-seal layer, and 0.25 mL of an electrolyte solution was added into the housing. A mixed solution in which LiPF₆ was dissolved at 1.0 mol/L in a mixed solvent of ethyl methyl carbonate, diethyl carbonate, and ethylene carbonate with a volume ratio of 50:20:30 was used as the electrolyte solution. The secondary battery was fabricated by heat-sealing the housing while reducing the pressure in the housing. A designed capacity of the secondary battery was 20.5 mAh.

### 3. Evaluation

The methods for evaluating the physical properties of the separators according to the Examples 1 and 2 and the Comparative Example 1 and the performance of the secondary batteries including the separators are described below.

### 3-1. Thickness

The thickness was measured using a High-Resolution Digital Measuring Unit manufactured by Mitsutoyo Corporation.

### 3-2. Temperature-Increase Convergence Time at Microwave Irradiation

A test piece of 8 cm×8 cm was cut out from the separator 130 and the weight W (g) was measured. Then, the weight per unit area was calculated according to the equation of the weight per unit area (g/m²)=W/(0.08×0.08).

Next, after dipping the test piece with a size of 8 cm×8 cm into a N-methylpyrrolidone to which 3 wt % of water was added, the separator was spread over a sheet of Teflon™ (size: 12 cm×10 cm) and then folded in half to sandwich an optical fiber thermometer (Neoptix Reflex thermometer manufactured by ASTECH corporation.) wrapped with polytetrafluoroethylene (PTFE).

Next, after the test piece impregnated in NMP with water sandwiching the thermometer was fixed in a microwave-irradiation apparatus (9 kW microwave oven with a frequency of 2455 Hz, manufactured by Micro Denshi Co. Ltd.) equipped with a turning table, a microwave was applied at 1800 W for 2 minutes.

The temperature variation of the test piece after starting the microwave irradiation was measured every 0.2 second using the aforementioned optical fiber thermometer. In this temperature measurement, the temperature at which no temperature increase was observed for 1 second or more was employed as the temperature-increase convergence temperature, and the time from starting the microwave irradiation until reaching the temperature-increase convergence temperature was used as a temperature-increase convergence time. The temperature-increase convergence time to the resin amount per unit area was calculated by dividing the temperature-increase convergence time by the weight per unit area of the separator.

### 3-3. Initial Rate Property

The assembled secondary battery 100 was subjected to a four-cycle initial charging/discharging where one cycle is performed with a current of 0.2 C (The rated value by the discharge capacity at a rate of 1 hour is set to 1 C for the current value to discharge in one hour. The same applies to the following.) in a voltage range from 4.1 to 2.7 Vat 25° C.

The secondary batteries which was subjected to the initial charging/discharging was further subjected to three cycles of charging and discharging at a constant current with a charging current of 1 C and discharging currents of 0.2 C and 20 C at 55° C. Then, the ratio (20 C discharge capacity/0.2 C discharge capacity) of the discharge capacity at the third cycle when the discharge current value is 0.2 C and 20 C, respectively, was calculated as the initial rate property.

3-4. Rate Property Retention Rate after Charge and Discharge Cycle

After the initial rate property measurement, the secondary batteries were subjected to 100-cycle charging/discharging where one cycle was performed at a constant current with a charging current of 1 C and a discharging current of 10 C in a voltage range from 4.2 V to 2.7 V at 55° C.

For the secondary battery 100 that has been charged and discharged for 100 cycles, three cycles of charging and discharging were carried out at a constant current with a charging current of 1 C and discharging currents of 0.2 C and 20 C at 55° C. A ratio of the discharge capacitances between at the discharge currents of 0.2 C and 20 C (20 C discharge capacitance/0.2 C discharge capacitance) in the third cycle were obtained as a rate property after the 100-cycle charging/discharging (a rate property after 100 cycles).

From the result of the rate test, the retention rate (%) of the rate property before and after the charge and discharge cycle was calculated according to the following equation.

Retention rate of the rate property=(rate property after 100 cycles)/(initial rate property)×100

### 3-5. Tearing Strength by Elmendorf Tearing Method

The tearing strength of the porous film (first layer 132) was measured according to “JIS K 7128-2 Test method for tearing strength of a plastic film and sheet-Part 2: Elmendorf tear method”. The measuring equipment and conditions used were as follows:

Equipment: Digital Elmendorf tear tester (manufactured by Toyo Seiki Seisaku-sho, Ltd., SA-WP type);

Sample size: Rectangular test piece shape based on JIS standard;

Condition: flying angle: 68.4°, number of measurements n=5;

The sample used for evaluation is cut out so that the direction to be torn at the time of measurement is perpendicular to the flow direction when the porous film to be measured is formed (hereinafter referred to as the TD direction). In addition, the measurement is carried out in a state where four to eight sheets of the porous film are stacked, and the measured tear load value is divided by the number of porous films to calculate the tearing strength per porous film. Thereafter, the tearing strength T per 1 μm thickness of the porous film was calculated by dividing the tearing strength per porous film by the thickness per film.

Specifically, the tearing strength T was measured according to the following equation.

T=(F/d)

(In the expression, T: fracturing strength (mN/μm)

F: Tear load (mN/piece)

d: Film thickness (μm/sheet))

The average value of the tearing strength at 5 points obtained after 5 measurements was taken as the true tearing strength (however, it was calculated excluding data with a deviation equal to or more than ±50% from the average value).

### 3-6. Tensile Elongation Value E Based on the Right Angle Method

The tearing strength of the porous film was measured based on “JIS K 7128-3 Test method for tearing strength of a plastic film and sheet—part 3: right-angled tear method” to create a load-tensile elongation curve. Thereafter, the value E of tensile elongation was calculated from the load-tensile elongation curve. In the measurement of tearing strength based on the right-angled tearing method, the measuring equipment and measurement conditions used are as follows:

Equipment: Universal material tester (manufactured by INSTRON, model 5582);

Sample size: Test piece shape based on JIS standard;

Conditions: tensile speed 200 mm/min, measurement number n=5 (however, except for the number of times the data with a deviation equal to or more than ±50% from the average value is excluded);

The sample used for evaluation was cut out so that the tearing direction was the TD direction. That is, the sample was cut out so as to have a long shape in the MD direction.

From the load-tensile elongation curve prepared based on the results of the above measurements, the value E (mm) of tensile elongation from the time the load reaches the maximum load until it attenuates to 25% of the maximum load was calculated with the method shown below.

A load-tension elongation curve was created, and the maximum load (load at the start of tearing) was defined as X (N). 0.25 times the value of X (N) was defined as Y (N). The value of tensile elongation until X attenuates to Y was defined as E0 (mm) (see the description of FIG. 1). The average value of E0 (mm) of 5 points obtained by measuring 5 times was defined as E (mm) (however, it is calculated excluding data with a deviation equal to or more than ±50% from the average value).

### 3-7. Test Force Measurement at Dielectric Breakdown

The test force at the time of dielectric breakdown was measured by a simple electrical conduction test by nail penetration using a measurement device of an electrical conduction test by nail penetration shown below. In the electrical conduction test by nail penetration, the porous films obtained by cutting the porous films obtained in Examples and Comparative Examples into a size of 5 mm×5 mm were used as a separator.

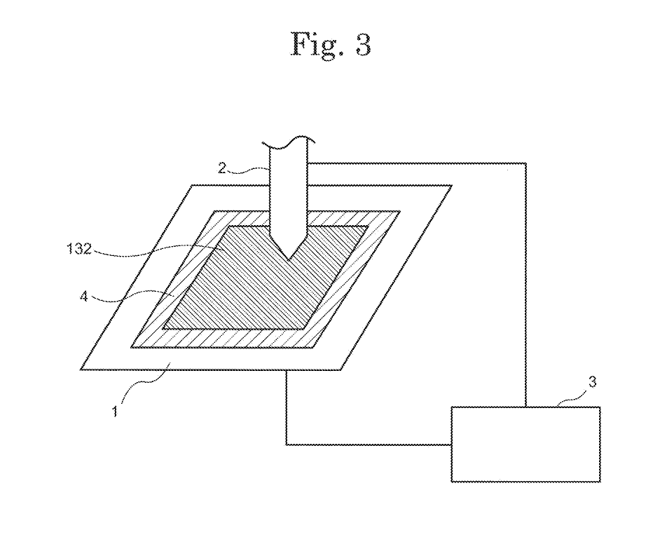

First, referring to FIG. 3, a measurement apparatus for the electrical conduction test by nail penetration will be described below.

As shown in FIG. 3, the measurement apparatus for the electrical conduction test by nail penetration, that is, the measurement apparatus for measuring the test force at the time of dielectric breakdown of the separator, comprises a SUS plate 1 (SUS304; 1 mm of thickness) as a mounting table on which separator 130 to be measured is mounted, a drive unit (not shown) that holds the N50 nail 2 specified in JIS A 5508 and moves the held nail 2 up and down at a constant speed, and a resistance measuring device 3 that measures the DC resistance between the nail 2 and the SUS plate 1, and a material testing machine (not shown) that measures the amount of deformation in the thickness direction of the separator and the force required for the deformation. The size of the SUS plate 1 was at least larger than the size of the separator 130, and specifically, it was 15.5 mmφ. The driving unit is disposed above the SUS plate 1 so as to hold the nail 2 so that the tip thereof is perpendicular to the surface of the SUS plate 1 and vertically moves the nail 2. As the resistance measuring device 3, a commercially available product “Digital Multimeter 7461P (manufactured by ADC Corporation)” was used. Further, as a material testing machine, a “Compact Table-Top Tester EZTest EZ-L (manufactured by SHIMADZU CORPORATION)” which is a commercially available product was used.

The measuring method of the test force at the time of the dielectric breakdown of the separator 130 (1st layer 132) using the measuring apparatus is demonstrated below.

First, the nail 2 is fixed to a load cell built in the crosshead of the drive unit of the material testing machine using a drill chuck type fixing jig. In addition, a fixing stand is placed on the lower jig mounting surface of the material testing machine, and a negative electrode sheet 4 to be a negative electrode of the secondary battery 100 is placed on the SUS plate 1 on the fixing stand, and the separator is placed on the negative electrode sheet 4. The amount of deformation in the thickness direction of the separator 130 is measured by the stroke of the crosshead of the material tester, and the force required for the deformation is measured by the load cell to which the nail 2 is fixed. Then, the nail 2 and the resistance measuring device 3, and the SUS plate 1 and the resistance measuring device 3 are electrically connected. Electrical connection was made using an electrical cord and a crocodile clip.

In addition, a sample produced by the method which consists of the process of following (i)-(iii) was used for the negative electrode sheet 4 used by the measurement:

(i) a process of adding and mixing 100 weight portions of an aqueous solution of carboxymethyl cellulose as a thickener and a binder (concentration of carboxymethyl cellulose; 1 wt %) and 2 weight portions of an aqueous emulsion of styrene butadiene rubber (concentration of styrene butadiene rubber; 50 wt %) to 98 weight portions of graphite powder as a negative electrode active material, then further adding 22 weight portions of water to make a slurry having a solid content concentration of 4 wt %;

(ii) a process of applying the slurry obtained in step (i) to a part of a 20 μm-thick rolled copper foil, which is a negative electrode current collector, so as to have a basis weight of 140 g/m², then drying, and rolling to a thickness of 120 μm with a press (100 μm thickness of negative-electrode active-substance layer);

(iii) a process of preparing a negative electrode sheet for a nail penetration test by cutting the rolled copper foil obtained in step (ii) so that the size of the portion where the negative-electrode active-substance layer is formed is 7 mm×7 mm.

Next, the drive unit was driven to lower the nail, and the tip of the nail was brought into contact with the surface (the outermost layer) of the separator and stopped (measurement preparation completed). Then, the state in which the tip end of the nail 2 was in contact with the surface of the separator 130 was taken as the displacement “0” in the thickness direction of the separator.

After completing the preparation for measurement, the drive unit was driven and lowering of the nail was started at a falling speed of 50 μm/min, while measuring the amount of deformation in the thickness direction of the separator 130 and the force required for deformation with a material tester, and the DC resistance between the nail 2 and the SUS plate 1 was measured with a resistance measuring instrument 3. The point at which the DC resistance first becomes equal to or smaller than 10,000Ω after the start of the measurement was taken as the dielectric breakdown point. Then, a test force (unit: N), which is a measurement force at the time of dielectric breakdown, was determined from the amount of deformation in the thickness direction of the separator at the dielectric breakdown point. Furthermore, the test force (N/μm) at dielectric breakdown was calculated by dividing the test force by the thickness of the separator.

That the test force (N/μm) at dielectric breakdown calculated by the above method is a large value, specifically equal to or larger than 0.12 N/μm, means that the separator 130 maintains its insulation performance when it receives a local impact caused by foreign matter or deformation from the outside. From the above reason, when the separator 130 is used for a secondary battery, it shows that it is possible to prevent the occurrence of an internal short circuit due to breakage or the like of the secondary battery 100, that is, the separator 130 (first layer 132) has high safety.

### 3-8. Pin-Pulling Evaluation Test

The separator (porous film) for the nonaqueous electrolyte-solution secondary battery in Examples and Comparative Examples was cut in a TD direction of 62 mm×MD direction of 30 cm, put on a 300 g weight, and wound five times around a stainless steel ruler (Shinwa Co., Ltd. product number: 13131). At this time, the separator was wound so that the TD of the separator and the longitudinal direction of the stainless steel ruler became parallel. Subsequently, at a speed of about 8 cm/sec, the stainless steel ruler was pulled out and the width of the separator was measured with a caliper. Before and after the stainless steel ruler was pulled out, the width in the TD direction of the 5-rolled part separator was measured with a caliper and the amount of change (mm) was calculated. The amount of change indicates the amount of expansion in the drawing direction when the separator starts to move in the drawing direction of the stainless steel ruler due to the frictional force between the stainless steel ruler and the separator, and the separator is deformed in a spiral.

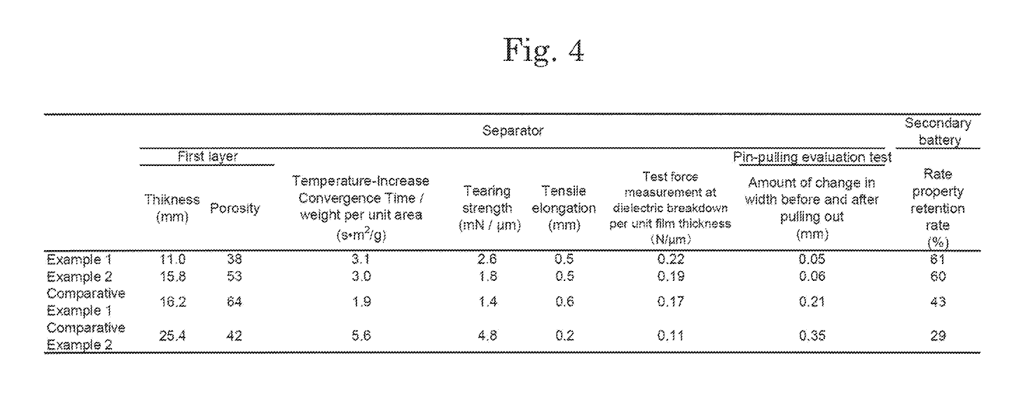

The above test results for the example and the comparative example are shown in FIG. 4. It is shown that the temperature-increase convergence time to the resin amount of the first layer 132 per unit area is in the range equal to or longer than 2.9 s·m²/g and equal to or shorter than 5.7 s·m²/g in the separator of the example when the separator first layer 132 is irradiated with a microwave of 2455 MHz at an output of 1800 W after being impregnated with N-methylpyrrolidone containing 3 wt % of water. In the separators of Example, the tearing strength of the first layer 132 measured by the Elmendorf tearing method (in accordance with JIS K 7128-2) is equal to or more than 1.5 mN/μm, and in the load-tensile elongation curve in the tearing strength measurement (in accordance with JIS K 7128-3) of the first layer 132 by the right-angled tearing method, it was shown that the tensile elongation value was equal to or more than 0.5 mm from when the load reaches the maximum load until it attenuates to 25% of the maximum load.

Therefore, the separators of Example of the present invention can suppress a decrease in a rate property when charging and discharging are repeated, and can suppress the occurrence of an internal short circuit against an external impact.

On the other hand, in the separator of Comparative Example 1, any of the above-described characteristics does not satisfy the above-described range. Therefore, the separator of Comparative Example 1 cannot sufficiently suppress the decrease in a rate property when charging and discharging are repeated. Moreover, the separator of the comparative example 1 cannot fully suppress the occurrence of an internal short circuit against the external impact. In addition, the separator of Comparative Example 2 which is a commercially available separator cannot sufficiently suppress the decrease in a rate property when charging and discharging are repeated, and cannot sufficiently suppress the occurrence of an internal short circuit against an external impact.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements is included in the scope of the present invention as long as it possesses the concept of the present invention.

It is understood that another effect different from that provided by the modes of the aforementioned embodiments is achieved by the present invention if the effect is obvious from the description in the specification or readily conceived by persons ordinarily skilled in the art.

### EXPLANATION OF REFERENCE NUMERAL

1: SUS plate, 2: Nail, 3: Resistance meter, 4: Negative electrode sheet, 100: Secondary battery, 110: Positive electrode, 112: Positive-electrode current collector, 114: Positive-electrode active-substance layer, 120: Negative electrode, 122: Negative-electrode current collector, 124: Negative-electrode active-substance layer, 130: Separator, 132: First layer, 134: Porous layer, 140: Electrolyte solution

1. A separator comprising:
a first layer consisting of a porous polyolefin,
wherein a temperature-increase convergence time to the amount of a resin in the first layer per unit area is equal to or longer than 2.9 s·m²/g and equal to or shorter than 5.7 s·m²/g when the first layer is irradiated with a microwave having a frequency of 2455 MHz with an output of 1800 W after the first layer is impregnated with N-methylpyrrolidone containing 3 wt % of water,
a tearing strength of the first layer measured by an Elmendorf tearing method (in accordance with JIS K 7128-2) is equal to or more than 1.5 mN/μm, and
wherein a tensile elongation value of the first layer is equal to or longer than 0.5 mm until a load decreases to 25% of a maximum load from when the load reaches the maximum load in a load-elongation curve in the tearing strength measurement (in accordance with JIS K 7128-3) of the first layer by the right-angled tearing method.

2. The separator according to claim 1, wherein the temperature-increase convergence time to the amount of the resin in the first layer per unit area is equal to or longer than 2.9 s·m²/g and equal to or shorter than 5.3 s·m²/g

3. The separator according to claim 1, further comprising a porous layer over the first layer.

4. A secondary battery comprising the separator according to claim 1.
